(19) United States
(12) Patent Application Publication
(10) Pub. No.: US 2011/0143702 A1
(43) Pub. Date: Jun. 16, 2011

(54) ELECTRONIC APPARATUS AND HOLD CONTROL METHOD

(75) Inventor: Takeshi HOSOKAWA, Fussa-shi (JP)

(73) Assignee: Kabushiki Kaisha Toshiba, Tokyo (JP)

(21) Appl. No.: 12/965,708

(22) Filed: Dec. 10, 2010

(30) Foreign Application Priority Data
Dec. 11, 2009 (JP) 2009-282110

(51) Int. Cl. H04B 1/08

(52) U.S. Cl. 455/347

(57) ABSTRACT

According to one embodiment, an electronic apparatus includes an antenna, a holding module, an exchange module, a reception module, a first controller, and a second controller. The holding module is provided near the antenna, and is configured to hold a second apparatus to the electronic apparatus. The exchange module is configured to exchange data with the second apparatus by close proximity wireless transfer via the antenna. The reception module is, using the exchange module, configured to receive data indicative of a movement of the second apparatus. The first controller is configured to control hold by the holding module, based on the data. The second controller is configured to control data exchange by the exchange module, based on the data.

### CROSS-REFERENCE TO RELATED APPLICATIONS

This application is based upon and claims the benefit of priority from Japanese Patent Application No. 2009-282110, filed Dec. 11, 2009; the entire contents of which are incorporated herein by reference.

### FIELD

Embodiments described herein relate generally to an electronic apparatus which executes close proximity wireless transfer, and a hold control method.

### BACKGROUND

Conventionally, there is known a positioning device which can fix an electronic apparatus at an exact position by an electromagnetic force without strictly performing alignment, when the electronic apparatus is to be set on a main apparatus, and which maintains a locked state even during communication (Jpn. Pat. Appln. KOKAI Publication No. H7-295939).

According to the positioning device disclosed in KOKAI Publication No. H7-295939, in the state in which a handy terminal (electronic apparatus) is set on a communication relay device (main apparatus), an upper electromagnet and a lower electromagnet, which are provided on the communication relay device, are driven during data communication, and thereby an upper ferromagnetic body and a lower ferromagnetic body, which are provided on the handy terminal, are attracted by the electromagnetic force of the upper and lower electromagnets. Thus, alignment is automatically performed between an infrared interface module on the communication relay device side and an infrared interface module on the handy terminal side.

In the prior art, as described above, the electronic apparatus and main apparatus can be aligned and fixed by the electromagnetic force. However, the electromagnets are driven after the electronic apparatus and main apparatus are set in the communication state. Specifically, the data communication is started before the alignment at a time point when the infrared interface module on the communication relay device side and the infrared interface module on the handy terminal side have been brought close to each other and data communication has been enabled.

In other words, since the data communication is started before the apparatuses communicating with each other are stably aligned, it is possible that a communication error occurs immediately after the data communication is started.

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1A and FIG. 1B are exemplary views showing external appearances of electronic apparatuses according to an embodiment;

FIG. 2 is an exemplary block diagram showing the system configuration of a personal computer in the embodiment;

FIG. 3 is an exemplary block diagram showing the main structure of a digital camera in the embodiment;

FIG. 4A and FIG. 4B are exemplary diagram showing arrangements of holding devices provided on the personal computer and digital camera in the embodiment;

FIG. 5 shows a state in which a close proximity wireless transfer antenna of the digital camera is brought close to a close proximity wireless transfer antenna of the personal computer in the embodiment;

FIG. 6 shows a state in which each of the personal computer and the digital camera fixes the communication counterpart apparatus to the own apparatus;

FIG. 7 is an exemplary flow chart illustrating a hold control process by the personal computer in the embodiment;

FIG. 8 is an exemplary flow chart illustrating a hold control process by the digital camera in the embodiment;

FIG. 9 is an exemplary diagram showing the relationship between a state detected by a sensor and a data communication function in the embodiment;

FIG. 10 is an exemplary diagram showing a message for informing a user that data communication in the embodiment is being executed;

FIG. 11 is an exemplary diagram showings an example of a message for informing a user that data communication in the embodiment has been disconnected; and

FIG. 12 is an exemplary diagram showing an example of a message for calling the user's attention.

### DETAILED DESCRIPTION

Various embodiments will be described hereinafter with reference to the accompanying drawings.

In general, according to one embodiment, an electronic apparatus comprises an antenna, a holding module, an exchange module, a reception module, a first controller, and a second controller. The holding module is provided near the antenna, and is configured to hold a second apparatus to the electronic apparatus. The exchange module is configured to exchange data with the second apparatus by close proximity wireless transfer via the antenna. The reception module is, using the exchange module, configured to receive data indicative of a movement of the second apparatus. The first controller is configured to control hold by the holding module, based on the data. The second controller is configured to control data exchange by the exchange module, based on the data.

An embodiment will now be described with reference to the accompanying drawings.

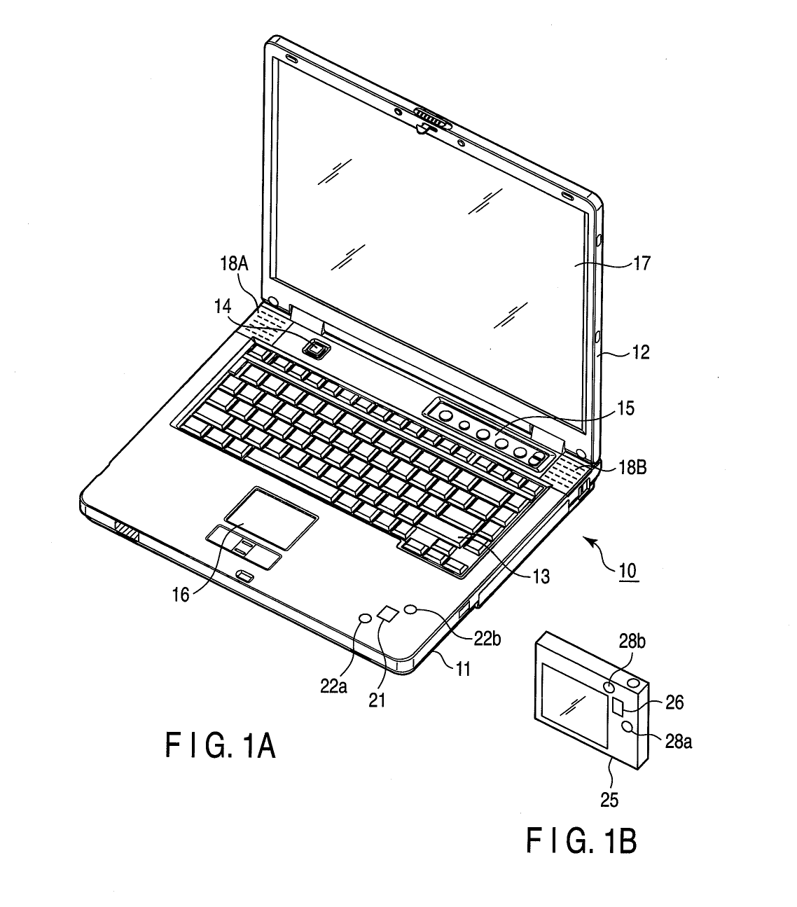

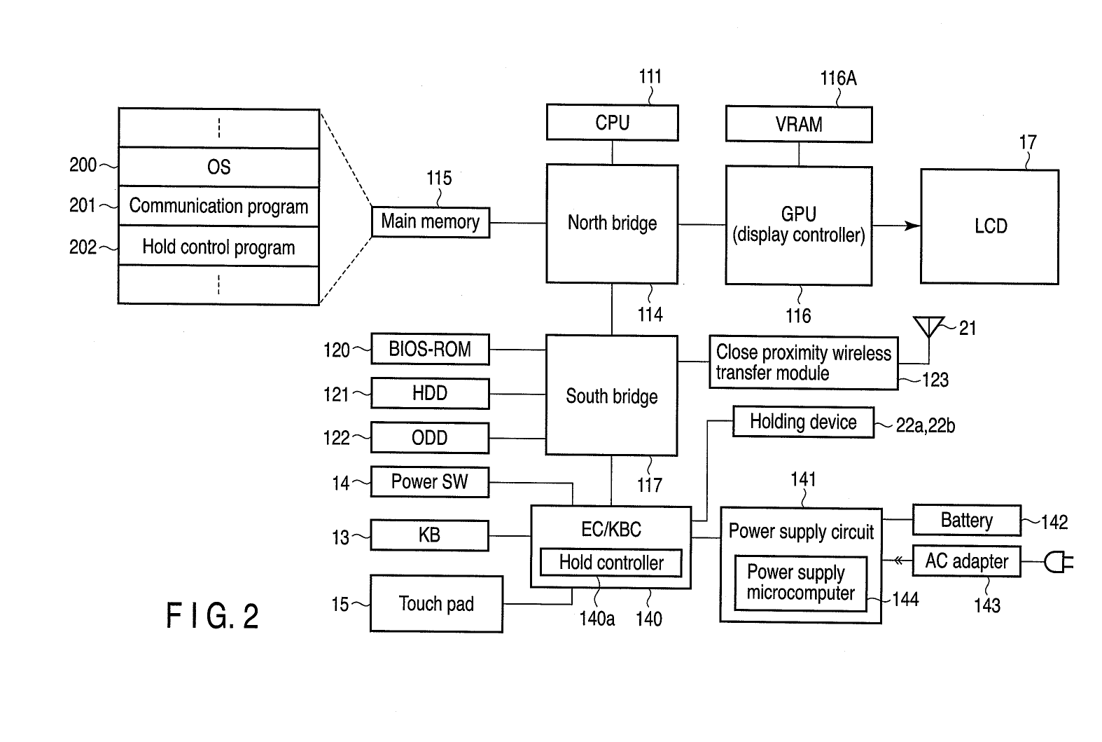

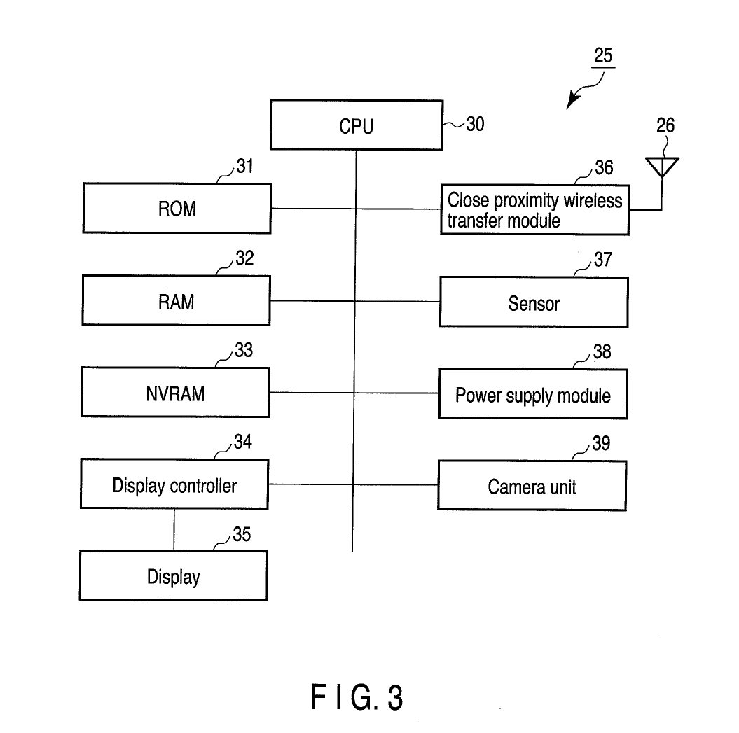

To begin with, referring to FIG. 1A, FIG. 1B, FIG. 2 and FIG. 3, the structures of electronic apparatuses according to the embodiment are described. The electronic apparatuses of the embodiment can transmit/receive various data files, etc. by close proximity wireless transfer, and are realized, for example, by a notebook-type personal computer 10 shown in FIG. 1A and a digital camera 25 shown in FIG. 1B. The description below is given, for example, of the case where close proximity wireless transfer is executed between the personal computer 10 and digital camera 25.

The electronic apparatuses are not limited to the personal computer 10 and digital camera 25, and may be other kinds of apparatuses having processors for executing programs and having close proximity wireless transfer functions, such as a mobile phone, a PDA (personal digital assistant), a portable audio/video payer, a digital video camera, and a portable car navigation apparatus.

FIG. 1A is a perspective view showing the computer 10 in the state in which a display unit thereof is opened. The computer 10 comprises a computer main body 11 and a display unit 12. A display device that is composed of an LCD (Liquid Crystal Display) 17 is built in the display unit 12.

The display unit 12 is attached to the computer main body 11 such that the display unit 12 is rotatable between an open position where the top surface of the computer main body 11 is exposed, and a closed position where the top surface of the computer main body 11 is covered. The computer main body 11 has a thin box-shaped housing. A keyboard 13, a power button 14 for power-on/power-off, an input operation panel 15, a touch pad 16, and speakers 18A and 18B are disposed on the top surface of the housing of the computer main body 11.

The input operation panel 15 is an input device for inputting an event corresponding to a pressed button. The input operation panel 15 includes a plurality of buttons for activating a plurality of functions.

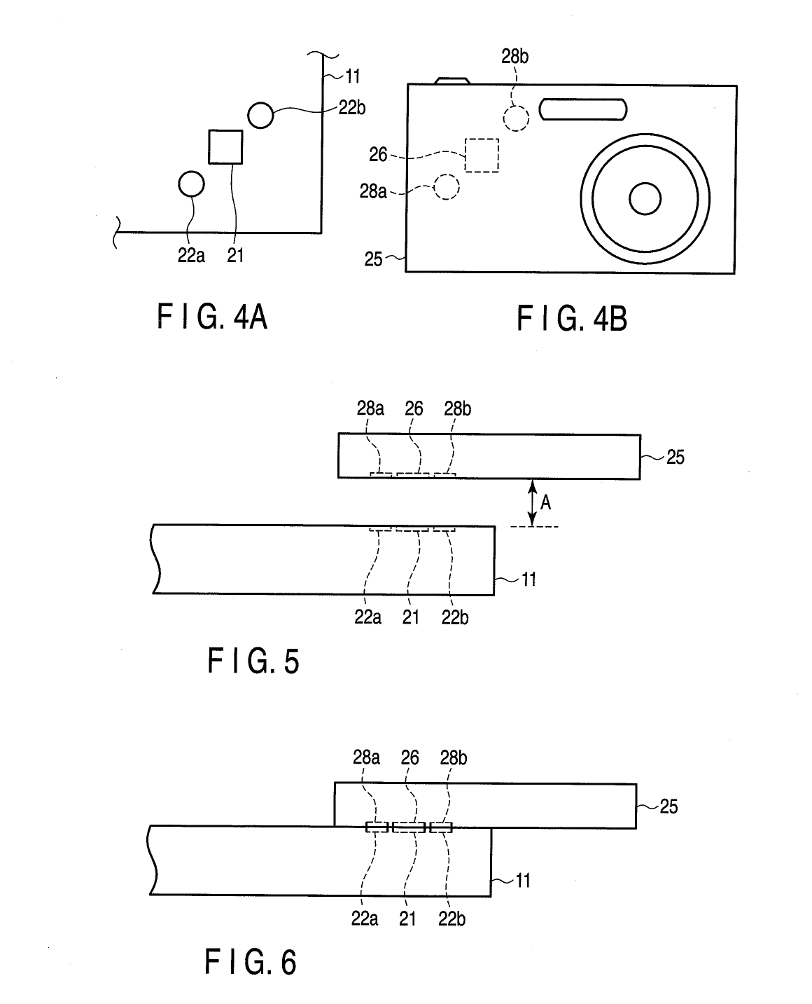

Further, an antenna 21 (coupler) for close proximity wireless transfer is provided on an upper surface portion of the computer main body 11. The personal computer 10 is provided with a close proximity wireless transfer function for wirelessly communicating with some other electric apparatus in the state in which the personal computer 10 is positioned close to the other electronic apparatus. The personal computer 10 executes data communication with the other electronic apparatus via the close proximity wireless transfer antenna 21. In addition, a plurality of holding devices 22a and 22b for fixing the other apparatus (e.g. digital camera 25), which is the object of close proximity wireless transfer, to the own apparatus are disposed in the vicinity of the close proximity wireless transfer antenna 21. The plural holding devices 22a and 22b are disposed at such a position that the close proximity wireless transfer antenna 21 is interposed therebetween (the details are shown in FIG. 4A). The holding devices 22a and 22b are composed of, for example, electromagnets, and the driving thereof can be controlled by turn-on/off of power.

On the other hand, the digital camera 25 shown in FIG. 1B is provided with a close proximity wireless transfer function for wirelessly communicating with the personal computer 10 in the state in which the digital camera 25 is positioned close to the personal computer 10. The digital camera 25 is provided with an antenna 26 (coupler) for close proximity wireless transfer, which is disposed, for example, on a back side of the housing thereof (usually, on the side where the display is provided). In addition, like the personal computer 10, a plurality of holding devices 28a and 28b for fixing the positional relationship to some other apparatus (e.g. personal computer 10), which is the object of close proximity wireless transfer, are disposed in the vicinity of the close proximity wireless transfer antenna 26. Like the holding devices 22a and 22b provided on the personal computer 10, the plural holding devices 28a and 28b are disposed at such a position that the close proximity wireless transfer antenna 26 is interposed therebetween (the details are shown in FIG. 4B). The holding devices 28a and 28b are composed of, for example, members (e.g. metallic members, magnets) which are attracted by magnetic force.

The positional relationship of the close proximity wireless transfer antenna 26 relative to the holding devices 28a and 28b, which are provided on the digital camera 25, is symmetric to the positional relationship of the close proximity wireless transfer antenna 21 relative to the holding devices 22a and 22b, which are provided on the personal computer 10 that is the counterpart of close proximity wireless transfer. In other words, if the close proximity wireless transfer antenna 26 of the digital camera 25 is opposed to and positioned close to the close proximity wireless transfer antenna 21 of the personal computer 10, the holding devices 22a and 22b are opposed to the holding devices 28a and 28b, respectively.

FIG. 2 is a block diagram showing the system configuration of the personal computer 10 in the embodiment.

As shown in FIG. 2, the personal computer 10 comprises a CPU 111, a north bridge 114, a main memory 115, a graphics processing unit (GPU) 116, a south bridge 117, a BIOS-ROM 120, a hard disk drive (HDD) 121, an optical disc drive (ODD) 122, a close proximity wireless transfer module 123, an embedded controller/keyboard controller IC (EC/KBC) 140, and a power supply circuit 141.

The CPU 111 is a processor which is provided in order to control the operation of the personal computer 10. The CPU 111 executes an operating system (OS) 200 and various application programs, which are loaded from the HDD 121 into the main memory 115. The various application programs include a communication program 201 (e.g. a close proximity wireless transfer driver) for controlling close proximity wireless transfer, and a hold control program 202 for executing a hold control process for fixing an apparatus, which is a communication counterpart of close proximity wireless transfer, to the own apparatus.

In addition, the CPU 111 also executes a system BIOS (Basic Input/Output System) which is stored in the BIOS-ROM 120. The system BIOS is a program for hardware control.

The north bridge 114 is a bridge device which connects a local bus of the CPU 111 and the south bridge 117. The north bridge 114 includes a memory controller which access-controls the main memory 115.

The GPU 116 is a display controller for controlling the LCD 17 which is used as a display monitor of the personal computer 10.

The GPU 116 executes a display process (graphics arithmetic process) for drawing frames on a video memory (VRAM) 116A, based on a drawing request which is sent from CPU 111 via the north bridge 114.

The south bridge 117 incorporates an IDE (Integrated Drive Electronics) controller and a Serial ATA controller for controlling the HDD 121 and optical disc drive (ODD) 122.

The close proximity wireless transfer module 123 is connected to the south bridge 117. The close proximity wireless transfer module 123 is an exchange module which executes close proximity wireless transfer via the antenna 21 (coupler) for close proximity wireless transfer. The close proximity wireless transfer module 123 establishes wireless connection to some other apparatus having a close proximity wireless transfer function, which is present within a predetermined distance, and transmits data such as files. The close proximity wireless transfer between the close proximity wireless transfer module 123 and the other apparatus is executed in a peer-to-peer mode. The range of communication is, e.g. 30 mm. The close proximity wireless transfer module 123 can execute close proximity wireless transfer when the distance between the close proximity wireless transfer antenna 21 and the antenna (coupler) of the other apparatus has decreased to within the range of communication. Then, transmission of data, such as a file which is explicitly designated by the user, or a predetermined data file which is to be synchronized, is executed between the close proximity wireless transfer module 123 and the other apparatus.

In the close proximity wireless transfer, an induction electric field is used. As a close proximity wireless transfer method, TransferJet™, for instance, can be used. TransferJet™ is a close proximity wireless transfer method which uses a UWB (ultra-wideband), and high-speed data communication can be realized.

The embedded controller/keyboard controller IC (EC/KBC) 140 is a 1-chip microcomputer in which an embedded controller for power management and a keyboard controller for controlling the keyboard (KB) 13 and touch pad 15 are integrated. The EC/KBC 140 has a function of powering on/off the personal computer 10 in response to the user's operation of the power button switch 14. The power-on/off control of the personal computer 10 is executed by the cooperation between the EC/KBC 140 and power supply circuit 141.

The EC/KBC 140 is provided with a hold controller 140a as a function for controlling the holding devices 22a and 22b. The hold controller 140a controls the driving of the holding devices 22a and 22b in cooperation with the close proximity wireless transfer which is executed by the close proximity wireless transfer module 123. The hold controller 140a acquires data indicative of the movement of apparatus, such as a stationary state/shaking state, from the other apparatus (digital camera 25) that is the counterpart of communication and is brought close to the close proximity wireless transfer antenna 21, and controls the driving (power supply) of the holding devices 22a and 22b, based on the acquired data.

The power supply circuit 141 generates operation power to the respective components by using power from a battery 142 which is attached to the computer main body 11, or power from an external power supply which is connected via an AC adapter 143. The power supply circuit 141 is provided with a power supply microcomputer 144. The power supply microcomputer 144 monitors the power supply (charge/discharge) to the respective components and battery 142, and the charging state (charging capacity (voltage)) of the battery 142. When the battery 142 and AC adapter 143 are connected, the power supply circuit 141 charges the battery 142 by the external power supply.

FIG. 3 is a block diagram showing the main structure of the digital camera 25 in the embodiment.

The digital camera 25 in the embodiment is equipped with a close proximity wireless transfer function for executing wireless communication with some other apparatus (personal computer 10) in the state in which the digital camera 25 is positioned near this other apparatus. When the digital camera 25 is positioned in such close proximity that close proximity wireless transfer with the personal computer 10 is enabled, the digital camera 25 transmits to the communication-counterpart apparatus the data indicative of the movement (shake) of the apparatus which is detected by a sensor 37 for detecting a shake, in a preparatory process (including, e.g. a negotiation process) prior to starting data communication. For example, stationary state data, which indicates that the digital camera 25 has been set in the stationary state, is transmitted. Thereby, the data communication of, e.g. a file designated by the user can be started after the personal computer 10 and digital camera 25 are fixed in the stable state.

As shown in FIG. 3, the digital camera 25 is provided with a CPU 30, a ROM 31, a RAM 32, an NVRAM (Non-volatile RAM) 33, a display controller 34, a display 35, a close proximity wireless transfer module 36 (antenna 26 (coupler) for close proximity wireless transfer), a sensor 37, a power supply module 38 and a camera unit 39.

The CPU 30 executes an overall control of the apparatus according to programs. The CPU 30 executes, e.g. a communication program to control close proximity wireless transfer by the close proximity wireless transfer module 36, and executes a hold control program to carry out a hold control process.

The ROM 31 stores various programs and data.

The RAM 32 temporarily stores various programs, which are executed by the CPU 30, and various data.

The NVRAM 33 stores various setup data, and data which is processed by various programs. For example, the NVRAM 33 stores files of images which are captured by the camera unit 39.

The display controller 34, under the control of the CPU 30, controls display on the display 35.

The display 35 is composed of, e.g. an LCD (Liquid Crystal Display), and displays information relating to the usual process by the digital camera 25.

The close proximity wireless transfer module 36 is a communication module which executes close proximity wireless transfer via the close proximity wireless transfer antenna 26. The close proximity wireless transfer module 36 is constructed like the close proximity wireless transfer module 123 which is provided in the personal computer 10. The close proximity wireless transfer module 36 can execute close proximity wireless transfer when the distance between the close proximity wireless transfer antenna 26 and the antenna (coupler) of the other apparatus has decreased to within the range of communication (e.g. 30 mm).

The sensor 37 detects a movement (shake) of the digital camera 25. As the sensor 37, use may be made of a shake sensor, an acceleration sensor, or a shake gyro sensor. Other sensors which are capable of sensing shakes are also usable. Based on a signal corresponding to a shake, which is output from the sensor 37, the CPU 30 can determine whether the digital camera 25 is in the stationary state or in the shaking state.

The power supply module 38 supplies power to the respective components.

The camera unit 39 is a unit for capturing an image under the control of the CPU 30. The file of an image captured by the camera unit 39 is recorded in the NVRAM 33. The image file, which is recorded in the NVRAM 33, can be transmitted to the personal computer 10 by using close proximity wireless transfer in accordance with the user's instruction.

The holding devices 22a and 22b of the personal computer 10 are composed of electromagnets, and attract the holding devices 28a and 28b of the digital camera 25 by the magnetic force. However, the other apparatus, which is the counterpart of close proximity wireless transfer, may be fixed by other methods. For example, the other apparatus may be attracted by air suction, or may be mechanically fixed.

The holding devices 28a and 28b of the digital camera 25 may be composed of electromagnets, like the holding devices 22a and 22b.

Next, a detailed description is given of the arrangements of the close proximity wireless transfer 21, 26 and the holding device 22a, 22b, 28a, 28b, which are disposed on the personal computer 10 and digital camera 25.

FIG. 4A shows the arrangement of the close proximity wireless transfer antenna 21 and the plural holding devices 22a and 22b, which are provided on the computer main body 11. The close proximity wireless transfer antenna 21 is attached to an upper surface portion of the computer main body 11. For example, it is assumed that the close proximity wireless transfer antenna 21 is amounted on a surface of the housing or on an inner side of the housing. The surface of the housing, where the close proximity wireless transfer antenna 21 is disposed, is formed in a predetermined shape or is provided with a mark, thereby to enable the user to recognize the position of the antenna 21 from the outside. As shown in FIG. 4A, the two holding devices 22a and 22b are disposed, for example, on a diagonal line, with the close proximity wireless transfer antenna 21 being interposed between the holding devices 22a and 22b.

FIG. 4B shows the positional relationship of the close proximity wireless transfer antenna 26 and the holding devices 28a and 28b, which are provided on the digital camera 25. As shown in FIG. 4B, the close proximity wireless transfer antenna 26 and the holding devices 28a and 28b are provided, for example, on the back side of the digital camera 25 (as indicated by broken lines). As shown in FIG. 4A and FIG. 4B, the positional relationship between the close proximity wireless transfer antenna 26 and the holding devices 28a and 28b is the same as that between the close proximity wireless transfer antenna 21 and the holding devices 22a and 22b which are provided on the personal computer 10. Accordingly, if the close proximity wireless transfer antenna 26 of the digital camera 25 is moved close to the close proximity wireless transfer antenna 21 of the personal computer 10, the holding devices 28a and 28b are opposed to the holding devices 22a and 22b of the personal computer 10 and these holding devices attract each other.

By the mutual attraction of the holding devices 22a, 22b, 28a and 28b, the positional relationship between the personal computer 10 and digital camera 25 is fixed. In addition, since the close proximity wireless transfer antenna 21, 26 is disposed such that the close proximity wireless transfer antenna 21, 26 is interposed between the holding devices 22a, 22b, 28a, 28b, the close proximity wireless transfer antenna 21 and close proximity wireless transfer antenna 26 are aligned and opposed to each other, and are fixed in close contact, by the mutual attraction between the holding devices 22a and 22b and the holding devices 28a and 28b. Therefore, the close-proximity state between the close proximity wireless transfer antenna 21 and close proximity wireless transfer antenna 26 at the time of data communication can be stabilized.

In the case where two holding devices 22a and 22b are disposed in association with one close proximity wireless transfer antenna 21 on the personal computer 10, one holding device 22a may be configured to attract the associated holding device of the other apparatus, and the other holding device 22b may be configured to be attracted by the associated holding device of the other apparatus that is the counterpart of communication.

For example, the holding device 22a of the personal computer 10 attracts the holding device 28a of the digital camera 25 by generating magnetic force, and the holding device 28b of the digital camera 25 attracts the holding device 22b of the personal computer 10 by generating magnetic force. In this case, even if a plurality of holding devices are disposed, it should suffice to execute driving control for one holding device alone, and the structure can be simplified.

In addition, the holding devices 28a and 28b, which are provided on the electronic apparatus, such as the small-sized portable digital camera 25, are formed of metallic material which is attracted by the holding devices 22a and 22b of the personal computer 10. Thereby, the mounting of the holding devices on the small-sized electronic apparatus can be made easy.

Furthermore, in the structure shown in FIG. 1, FIG. 4A and FIG. 4B, the two holding devices 22a and 22b are provided in association with the single close proximity wireless transfer antenna 21. Alternatively, three or more holding devices may be disposed. In this case, the three or more holding devices should preferably be disposed in a manner to surround the close proximity wireless transfer antenna 21.

Besides, in FIG. 1, FIG. 4A and FIG. 4B, each of the holding devices 22a and 22b has a circular shape. Alternatively, the holding devices 22a and 22b may have other shapes. In this case, it is possible to adopt such a structure that a single holding device is provided, if the shape of this holding device that is disposed on the computer main body 11 can specify the position of the close proximity wireless transfer antenna 21 relative to the holding device.

FIG. 5 shows the state in which the close proximity wireless transfer antenna 26 of the digital camera 25 is brought close to the close proximity wireless transfer antenna 21 of the personal computer 10.

As shown in FIG. 5, when the close proximity wireless transfer antenna 21 is opposed to the close proximity wireless transfer antenna 26, the holding devices 22a and 22b are opposed to the holding devices 28a and 28b. If the digital camera 25 is positioned close to the personal computer 10 within a distance A in which close proximity wireless transfer is enabled, the digital camera 25 and personal computer 10 can be set in the communicable state. Since the close proximity wireless transfer antenna 21, 26 makes use of induction electric field, a high gain can be obtained at the distance (e.g. 30 mm) in which close proximity wireless transfer is enabled, and the state in which close proximity wireless transfer is enabled can be detected.

If the personal computer 10 in the embodiment is set in the state in which close proximity wireless transfer is enabled, the personal computer 10 drives the holding devices 22a and 22b to attract the counterpart apparatus of communication.

FIG. 6 shows the state in which each of the personal computer 10 and the digital camera 25 fixes the counterpart apparatus of communication to the own apparatus.

As shown in FIG. 6, the holding device 22a and holding device 28a are mutually opposed and fixed, and the holding device 22b and holding device 28b are mutually opposed and fixed. Thus, the close proximity wireless transfer antennas 21 and 26 are fixed in the neighboring state (in the close contact state in this example).

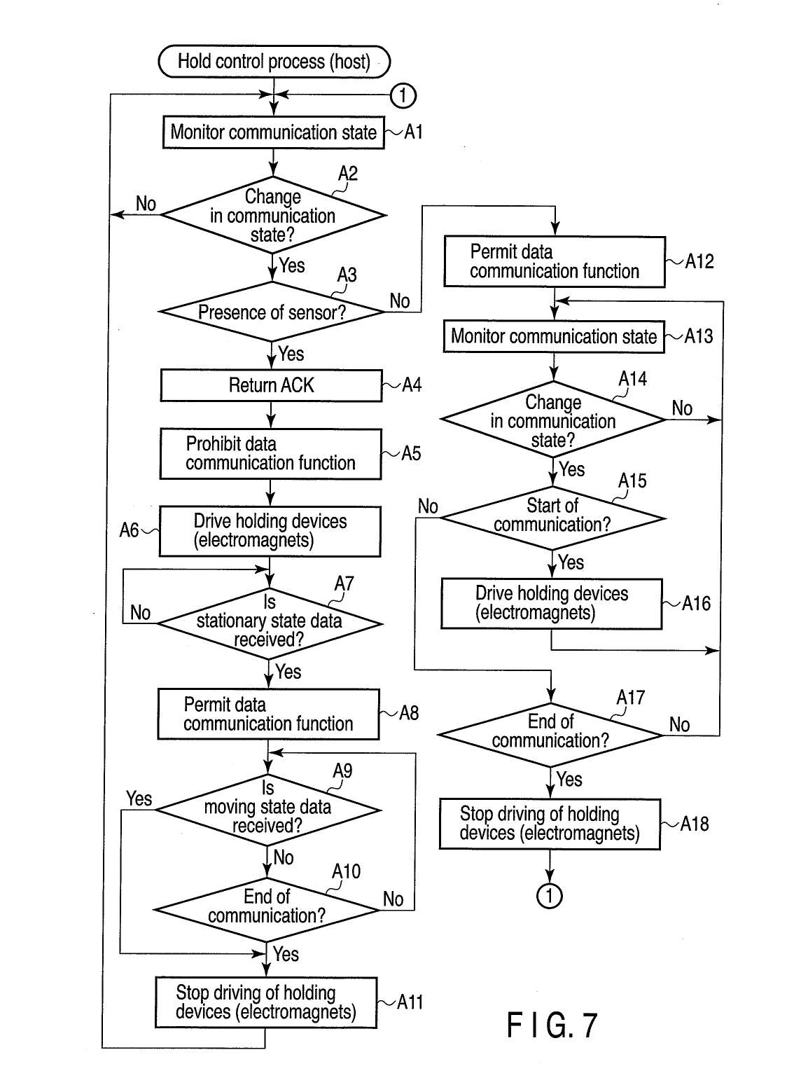

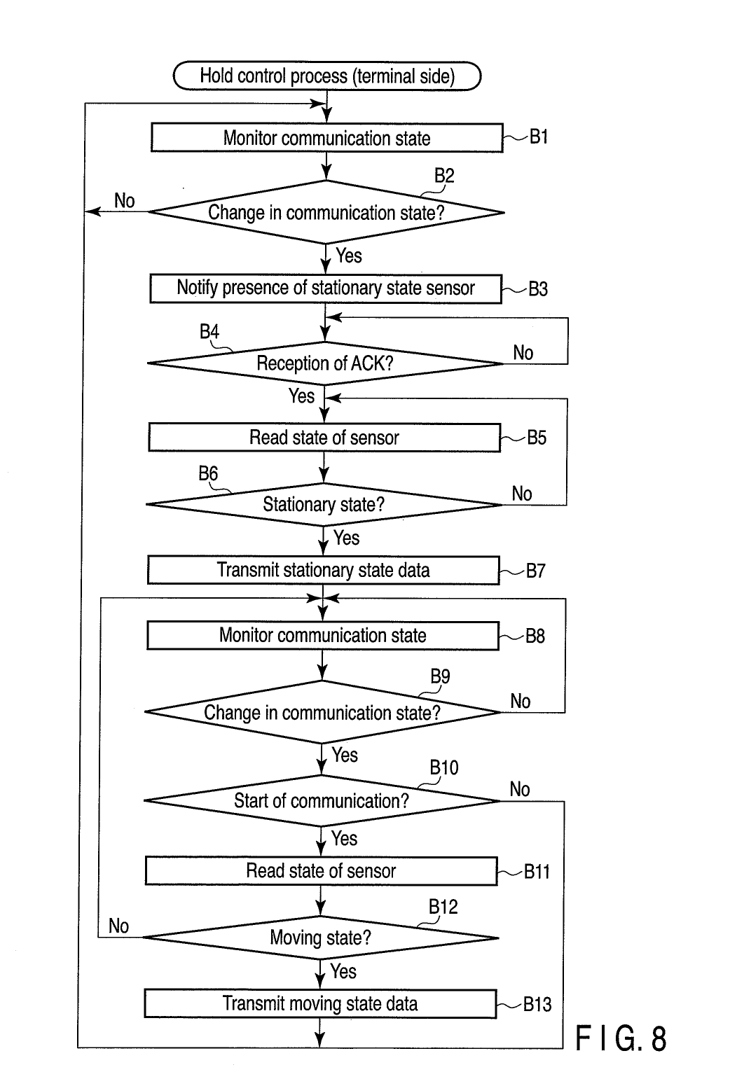

Next, the hold control process in the embodiment is described with reference to flow charts. FIG. 7 is a flow chart illustrating a hold control process by the personal computer 10, and FIG. 8 is a flow chart illustrating a hold control process by the digital camera 25.

A description is given, for example, of the case in which the personal computer 10 is set as a host-side apparatus, the digital camera 35 is set as a terminal (slave)-side apparatus, and a file (e.g. image file) recorded in the digital camera 25 is transmitted to the personal computer 10 by close proximity wireless transfer and is stored in the personal computer 10.

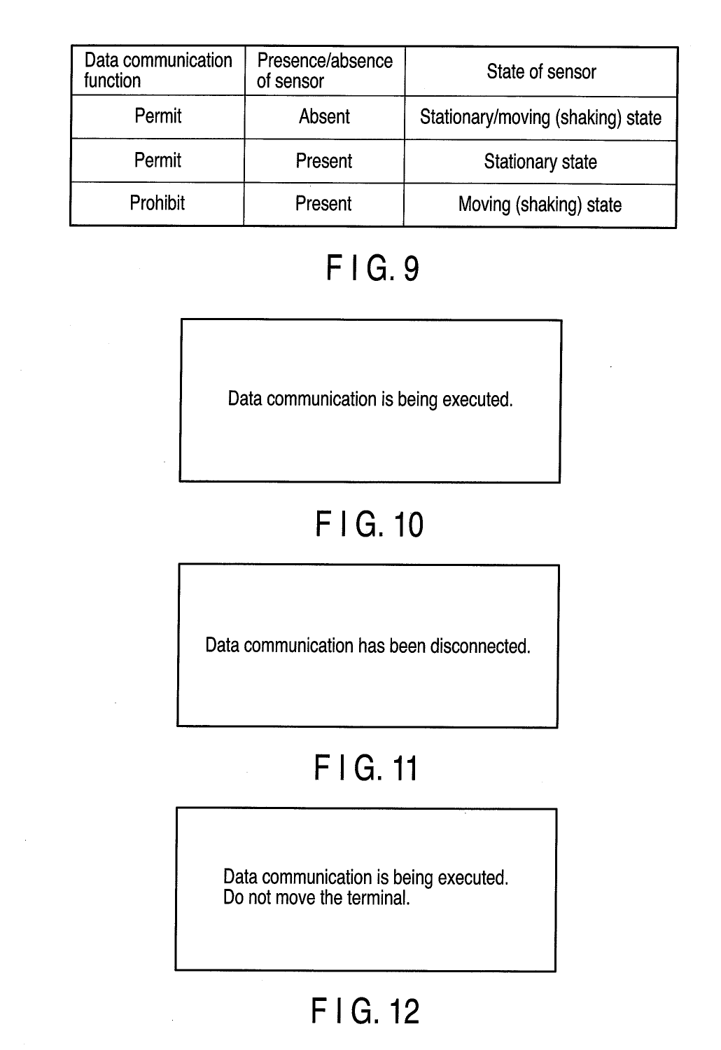

The personal computer 10 in the embodiment can permit/prohibit the data communication function in accordance with a state which is detected by the sensor 37 of the terminal (digital camera 25) that is the counterpart of communication. FIG. 9 shows the relationship between the states detected by the sensor 37 and the data communication function.

If the terminal that is the counterpart of communication is not provided with the sensor 37, the personal computer 10 executes control to permit data communication by the data communication function, regardless of whether the terminal is in the stationary state or in the moving state (shaking state).

If the terminal that is the counterpart of communication is provided with the sensor 37, the personal computer 10 executes control to permit data communication by the data communication function while the terminal is in the stationary state, and to prohibit data communication by the data communication function while the terminal is in the moving state. In other words, the personal computer 10 executes data communication when it is confirmed that the personal computer 10 and the terminal that is the counterpart of communication are set in the stable fixed state by driving the holding devices 22a and 22b.

Assume now that the communication program 201 is executed and the personal computer 10 is in the state in which close proximity wireless transfer is enabled by the close proximity wireless transfer module 123. In addition, the hold control program 202 is activated, and the hold controller 140a starts control on the holding devices 22a and 22b.

On the other hand, it is assumed that the execution of data transmission by close proximity wireless transfer is instructed in the digital camera 25 by the user operation, and a file which is to be transmitted is set. Thereby, in the digital camera 25, it is assumed that the communication program and hold control program are started and the close proximity wireless transfer is enabled by the close proximity wireless transfer module 36.

The hold controller 140a of the personal computer 10 monitors the state of communication by the close proximity wireless transfer module 123 (block A1). If there is no change in the communication state (No in block A2), the hold controller 140a continues monitoring the state of communication by the close proximity wireless transfer module 123 (block A1).

Similarly, the CPU 30 of the digital camera 25 monitors the state of communication by the close proximity wireless transfer module 36 (block B1, B2).

It is now assumed that the digital camera 25 is brought close to the personal computer 10, and that the distance between the close proximity wireless transfer antenna 21 of the personal computer 10 and the close proximity wireless transfer antenna 26 of the digital camera 25 has decreased to within the range in which close proximity wireless transfer is enabled. In this case, the personal computer 10 and digital camera 25 execute preparatory processes for executing data communication by close proximity wireless transfer via the close proximity wireless transfer module 123 and close proximity wireless transfer module 36. Specifically, a process for establishing physical connection and a negotiation process are executed.

In the negotiation process, session information relating to a session to be established, for example, session information including information indicative of a communication adapter to be used, information indicative of the kind of data to be transmitted by an application and information discriminating the application, is transmitted/received, and the session to be used by the application is established and the application which executes data communication is started.

The digital camera 25 informs the personal computer 10 that the sensor 37 for detecting the movement of the apparatus is mounted in the digital camera 25 (block B3). If the hold controller 140a receives the information indicative of the presence of the sensor 37 via the close proximity wireless transfer module 123 (Yes in block A3), the hold controller 140a returns an acknowledgement to the digital camera 25 (block A4).

In the case of executing close proximity wireless transfer with the sensor-equipped apparatus, the hold controller 140a prohibits the data communication function by the communication program 201 in order to start data communication after the apparatuses are set in the stable fixed state (block A5). In addition, the hold controller 140a drives the holding devices 22a and 22b (electromagnets) (block A6).

On the other hand, upon receiving the acknowledgement from the personal computer 10 (Yes in block B4), the CPU 30 of the digital camera 25 reads a signal which is output from the sensor 37 and determines whether the digital camera 25 is in the stationary state or not (block B5). For example, the CPU 30 determines that the digital camera 25 is in the stationary state, when the value of the signal that is output from the sensor 37 is lower than a preset reference value at which the stationary state is determined.

For example, while the user is holding the digital camera 25 and is positioning the holding devices 22a and 22b of the personal computer 10 and the holding devices 28a and 28b of the digital camera 25, the digital camera 25 is being moved. Thus, the digital camera 25 is not determined to be in the stationary state. Thereafter, if the holding devices 28a and 28b are attracted by the holding devices 22a and 22b by the electromagnetic force and the personal computer 10 and digital camera 25 are set in the fixed state, the digital camera 25 determines that the digital camera 25 is set in the stationary state, based on the signal that is output from the sensor 37. For example, if the digital camera 25 is placed on the top surface of the computer main body 11, it is determined that the digital camera 25 is set in the completely stationary state.

If the digital camera 25 is determined to be in the stationary state (Yes in block B6), the CPU 30 of the digital camera 25 transmits stationary state data, which indicates that the digital camera 25 is set in the stationary state, to the personal computer 10 via the close proximity wireless transfer module 36 (block B7). Then, the CPU 30 starts data communication of the file which is set as the object of transmission by the user.

If the stationary state data is received via the close proximity wireless transfer module 123 (Yes in block A7), the hold controller 140a of the personal computer 10 permits the data communication function by the communication program 201 (block A8).

Thereby, the data communication by the close proximity wireless transfer is executed between the digital camera 25 and the personal computer 10. By the data communication function of the communication program 201, the personal computer 10 receives via the close proximity wireless transfer module 123 the data (e.g. image file) which is transmitted from the digital camera 25 (close proximity wireless transfer module 36), and stores the received data in the main memory 115 or HDD 121.

As has been described above, in the personal computer 10 in the embodiment, the data communication can be started after it is confirmed that the digital camera 25 that is the counterpart of communication is in the stationary state. Specifically, the close proximity wireless transfer is executed in the stable state in which the holding devices 22a and 22b of the personal computer 10 and the holding devices 28a and 28b of the digital camera 25 are attracted by the magnetic force and the close proximity wireless transfer antennas 21 and 26 of the personal computer 10 and digital camera 25 are exactly aligned. Thus, even immediately after the start of the data communication, no communication error occurs.

In the personal computer 10, if the data communication by close proximity wireless transfer is started, the hold control program 202, for example, causes the LCD 17 to display a message informing the user that the data communication is being executed. FIG. 10 shows an example of the screen, which displays a message “Data communication is being executed.” for informing the user that data communication is being executed. Thereby, it is possible to alert the user not to move the digital camera 25 which is executing the close proximity wireless transfer.

If the CPU 30 of the digital camera 25 detects that a change has occurred in the communication state by the start of the data communication (block B8, Yes in block B9), the CPU 30 reads the state of the sensor 37, for example, each time one file, which is designated as the object of transmission by the user, is transmitted, and the CPU 30 determines whether the digital camera 25 is in the stationary state or in the moving state (block B11).

If it is determined that the digital camera 25 is not in the moving state (No in block B12), the CPU 30 successively monitors the state of the data communication by the close proximity wireless transfer (block B8).

On the other hand, if it is determined, based on the state of the sensor 37, that the digital camera 25 is in the moving state (Yes in block B12), the CPU 30 transmits, via the close proximity wireless transfer module 36, moving state data which indicates that the digital camera 25 is in the moving state (block B13). Specifically, if the digital camera 25 that is placed on the computer main body 11 is moved and the data communication by the close proximity wireless transfer is disconnected, the digital camera 25 notifies the personal computer 10.

If the moving state data is received via the close proximity wireless transfer module 123 (No in block A9), the hold controller 140a stops the driving of the holding devices 22a and 22b (i.e. releases the fixation (block A11). In addition, the data communication function by the communication program 201 interrupts the close proximity wireless transfer with the digital camera 25. In this case, in the personal computer 10, the hold control program 202 causes the LCD 17 to display a message informing the user that the data communication has been disconnected. FIG. 11 shows an example of the screen, which displays a message “Data communication has been disconnected.” for informing the user that data communication has been disconnected.

In the above description, in block B11, if the moving state has been determined from the state of the sensor 37, the moving state data is transmitted to the personal computer 10 and the data communication is terminated. Alternatively, the level of the moving state may be determined with plural levels, and the moving state data indicative of the moving state level may be transmitted. For example, when a shake at such a level that the data communication by the close proximity wireless transfer can be continued, although the digital camera 25 is not in the stationary state, the digital camera 25 transmits the moving state data indicative of a low-level moving state to the personal computer 10.

In this case, in the personal computer 10, the hold control program 202 causes the LCD 17 to display a message for alerting the user not to move the terminal (digital camera 25) that is the counterpart of communication. FIG. 12 shows an example of the screen, which displays a message “Data communication is being executed. Do not move the terminal.” for alerting the user.

The message for alerting the user is not limited to the example shown in FIG. 12, and may be some other output mode such as an output of sound. In addition, the content of the message may be altered according to the difference in level of the moving state.

As described above, based on the moving state detected by the sensor 37 of the digital camera 25, the personal computer 10 can inform the user of the message during the data communication. It is thus possible to call the user's attention so that stable data communication by close proximity wireless transfer is continued.

In the above description, the messages shown in FIG. 10, FIG. 11 and FIG. 12 are displayed on the personal computer 10. Needless to say, such messages may be displayed on the digital camera 25.

On the other hand, in block A3, if the information of the presence of the sensor is not sent from the apparatus that is the counterpart of close proximity wireless transfer (No in block A3), the personal computer 10 permits the data communication function (block A12). In other words, the personal computer 10 starts communication by the data communication function, regardless of whether the other apparatus that is the counterpart of communication is in the stationary state or in the moving state.

The hold controller 140a monitors the state of the communication by the close proximity wireless transfer module 123 (block A13). If the hold controller 140a detects the start of data communication, (Yes in block A14, Yes in block A15), the hold controller 140a drives the holding devices 22a and 22b (block A16).

By being driven by the hold controller 140a, the holding devices 22a and 22b generate magnetic force, and function to attract the holding devices 28a and 28b provided on the digital camera 25 which is positioned in close proximity.

As a result, as shown in FIG. 6, the personal computer 10 and digital camera 25 are fixed in the state in which the close proximity wireless transfer antenna 21 of the personal computer 10 and the close proximity wireless transfer antenna 26 of the digital camera 25 are put in close contact.

On the other hand, if there is a change in the communication state of data communication by the close proximity wireless transfer module 123 (Yes in block A14) and this change is the end of communication (Yes in block A17), the hold controller 140a stops the driving of the holding devices 22a and 22b.

Thereby, the fixed state of the personal computer 10 and digital camera 25 is released, and the digital camera 25 can be separated from the personal computer 10.

In the meantime, in blocks A11 and A18, instead of completely stopping the driving of the holding devices 22a and 22b, it is possible to control the holding devices 22a and 22b so as to weaken the strength of fixation. Thereby, for example, in such a case that data communication is executed in the state in which the digital camera 25 is placed on the personal computer 10, it is possible to prevent such a situation from occurring that the fixation is released at the same time as the end of the data communication and the digital camera 25 falls from the personal computer 10.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
an antenna;
a holder near the antenna, and configured to hold a second apparatus;
an exchange module configured to exchange data with the second apparatus by close proximity wireless transfer via the antenna;
a reception module configured to receive data indicative of a movement of the second apparatus via the exchange module;
a first controller configured to control a state of holding by the holder, based on the data; and
a second controller configured to control data exchange via the exchange module, based on the data.

2. The electronic apparatus of claim 1, wherein the second controller is configured to control the exchange module in order to start data exchange when first data indicating that the second apparatus is in a static state, is received by the reception module.

3. The electronic apparatus of claim 2, wherein the first controller is configured to control the holder in order to release the second apparatus, when second data indicating that the second apparatus is in a moving state, is received during the data exchange.

4. The electronic apparatus of claim 1, further comprising an output module configured to output a message when third data indicative of a level of a moving state of the second apparatus, is received by the reception module.

5. The electronic apparatus of claim 1, wherein the first controller is configured to control the state of holding in accordance with a start and an end of data exchange by the exchange module, when the data is unavailable.

6. An electronic apparatus comprising:
an antenna;
an exchange module configured to exchange data with a second apparatus by close proximity wireless transfer via the antenna;
a sensor configured to detect a movement; and
a transmitter, configured to transmit data indicative of the movement in accordance with detection of the movement by the sensor via the exchange module.

7. The electronic apparatus of claim 6, wherein the transmitter is configured to transmit first data indicating that the electronic apparatus is in a static state, when the sensor detects that the electronic apparatus is in the static state.

8. The electronic apparatus of claim 6, wherein the transmitter is configured to transmit second data indicative of a level of a moving state, in accordance with the detection of the movement by the sensor.
